(19) United States
(12) Patent Application Publication
(10) Pub. No.: US 2007/0112985 A1
(43) Pub. Date: May 17, 2007

(54) Bi-directional data transfer between a mobile phone and a computing device

(76) Inventors: Fred Fu-Yiu Law, Hong Kong S.A.R. (CN); Eddie Chi-Kit Yung, Hong Kong S.A.R. (CN)

Correspondence Address: LIU & LIU, 444 S. FLOWER STREET SUITE 1750, LOS ANGELES, CA, 90071, US

(21) Appl. No.: 10/567,129

(22) PCT Filed: Jan. 21, 2005
(86) PCT No.: PCT/CN05/00091

§ 371 Date: Feb. 1, 2006

(30) Foreign Application Priority Data
Jan. 21, 2004 (HK) 04100504.5

(51) Int. Cl. G06F 13/00

(52) U.S. Cl. 710/110

(57) ABSTRACT

A process for bi-directionally transferring data between a mobile phone and a computing device is provided. According to an exemplary embodiment of the present invention, a user may select between an uploading mode and a downloading mode. If the downloading mode is selected, a first data is firstly downloaded from the mobile phone to an intermediate device under a first master-slave protocol, where the intermediate device herein acts as a master device under the first master-slave protocol. Thereafter, the first data is further transmitted from the intermediate device to the computing device under a second master-slave protocol, where the intermediate device herein acts as a slave device under the second master-slave protocol. If the uploading mode is selected, a second data is firstly transmitted from the computing device to the intermediate device under the second master-slave protocol, where the intermediate device herein acts as a slave device under the second master-slave protocol. Then, the second data is uploaded from the intermediate device to the mobile under the first master-slave protocol, where the intermediate device herein acts as a master device under the first master-slave protocol.

### BACKGROUND

1. Field of the Invention

The present invention relates generally to data exchange between electrical devices, and more particularly to bi-directional data transfer between a mobile phone and a computing device.

2. Background of the Invention

Mobile phone users periodically may need to upload information stored in the mobile phone to a computing device, for example a personal computer, for backup purposes. Conventionally a cable is used to connect the computer and the mobile for data transfer therebetween. However, the cable does not have any storage function and needs to work in connection with both the computer and the mobile phone simultaneously for such data exchange Furthermore, a particular software generally needs to be installed on the computer for reading data from or transferring data to the mobile phone over the cable. Such a software installation requirement may not be convenient, especially since the user may need to re-install the software whenever the computer or its operating system is upgraded or reinstalled.

Therefore, there has been a need for a mechanism, which allows more convenient bidirectional data transfer between a mobile phone and a computing device.

### SUMMARY OF THE INVENTION

According to an aspect of present invention, a process for bi-directionally transferring data between a mobile phone and a computing device is provided. According to an exemplary embodiment of the present invention, a user may select between an uploading mode and a downloading mode. If the downloading mode is selected, a first data is firstly downloaded from the mobile phone to an intermediate device under a first master-slave protocol, where the intermediate device herein acts as a master device under the first master-slave protocol. Thereafter, the first data is further transmitted from the intermediate device to the computing device under a second master-slave protocol, where the intermediate device herein acts as a slave device under the second master-slave protocol. If the uploading mode is selected, a second data is firstly transmitted from the computing device to the intermediate device under the second master-slave protocol, where the intermediate device herein acts as a slave device under the second master-slave protocol. Then, the second data is uploaded from the intermediate device to the mobile under the first master-slave protocol, where the intermediate device herein acts as a master device under the first master-slave protocol.

According to a second aspect of the present invention, a medium having a program recorded thereon is provided. The program makes an intermediate device execute a procedure including the following steps for bi-directionally transferring data between a mobile phone and a computing device:
selecting between an uploading mode and a downloading mode;
if the downloading mode is selected,
   firstly downloading a first data from the mobile phone to the intermediate device under a first master-slave protocol, wherein the intermediate device herein acts as a master device under the first master-slave protocol; and
   secondly transmitting the first data from the intermediate device to the computing device under a second master-slave protocol, wherein the intermediate device herein acts as a slave device under the second master-slave protocol; and
if the uploading mode is selected,
   firstly transmitting a second data from the computing device to the intermediate device under the second master-slave protocol, wherein the intermediate device herein acts as a slave device under the second master-slave protocol; and
   secondly uploading the second data from the intermediate device to the mobile under the first master-slave protocol, wherein the intermediate device herein acts as a master device under the first master-slave protocol.

According to a third aspect of the present invention, a computer program element which makes an intermediate device execute a procedure is provided. The procedure includes the following steps for bi-directionally transferring data between a mobile phone and a computing device:
selecting between an uploading mode and a downloading mode;
if the downloading mode is selected,
   firstly downloading a first data from the mobile phone to the intermediate device under a first master-slave protocol, wherein the intermediate device herein acts as a master device under the first master-slave protocol; and
   secondly transmitting the first data from the intermediate device to the computing device under a second master-slave protocol, wherein the intermediate device herein acts as a slave device under the second master-slave protocol; and
if the uploading mode is selected,
   firstly transmitting a second data from the computing device to the intermediate device under the second master-slave protocol, wherein the intermediate device herein acts as a slave device under the second master-slave protocol; and
   secondly uploading the second data from the intermediate device to the mobile under the first master-slave protocol, wherein the intermediate device herein acts as a master device under the first master-slave protocol.

According to a fourth aspect of the present invention, a process for bi-directionally transferring data between a mobile phone and a computing device includes
selecting between an uploading mode and a downloading mode;
if the downloading mode is selected,
   firstly downloading a first data from the mobile phone to an intermediate device under a first protocol; and
   secondly transmitting the first data from the intermediate device to the computing device under a second protocol; and
if the uploading mode is selected,
   firstly transmitting a second data from the computing device to the intermediate device under the second protocol; and
   secondly uploading the second data from the intermediate device to the mobile under the first protocol.

According to another aspect of the present invention, an intermediate device for assisting bidirectional data transfer between a mobile phone and a computing device includes a mobile phone interface for connecting to the mobile phone, a computing device interface for connecting to the computing device, a controller for controlling data flow through the mobile phone interface and the computing device interface and a user interface for allowing a user to select the intermediate device to work in an uploading mode or a downloading mode. If the uploading mode is selected, the controller controls to receive a second data from the computing device to the intermediate device through the computing device interface under a second protocol, and further controls to upload the second data from the intermediate device to the mobile through the mobile phone interface under a first protocol.

Other aspects and advantages of the invention will become apparent from the following detailed description, taken in conjunction with the accompanying drawings, which description illustrates by way of example the principles of the invention.

### BRIEF DESCRIPTION OF THE DRAWINGS

FIG. 1 is a plan view of an intermediate device embodiment useful in an exemplary bidirectional data transfer process of the present invention;

FIG. 2 illustrates a simplified diagram of the intermediate device of FIG. 1;

FIG. 3 illustrates communications between the intermediate device and other devices in the exemplary bi-directional data transfer process of the present invention;

FIG. 4 is a flow chart step-by-step illustrating the exemplary bidirectional data transfer process of the present invention;

FIG. 5 is a flow chart step-by-step illustrating a security check step in FIG. 4;

FIG. 6 is a snap-shot of a data editor on a personal computer useful in the present invention; and

FIG. 7 is another snap-shot of the data editor of FIG. 6.

### DETAILED DESCRIPTION

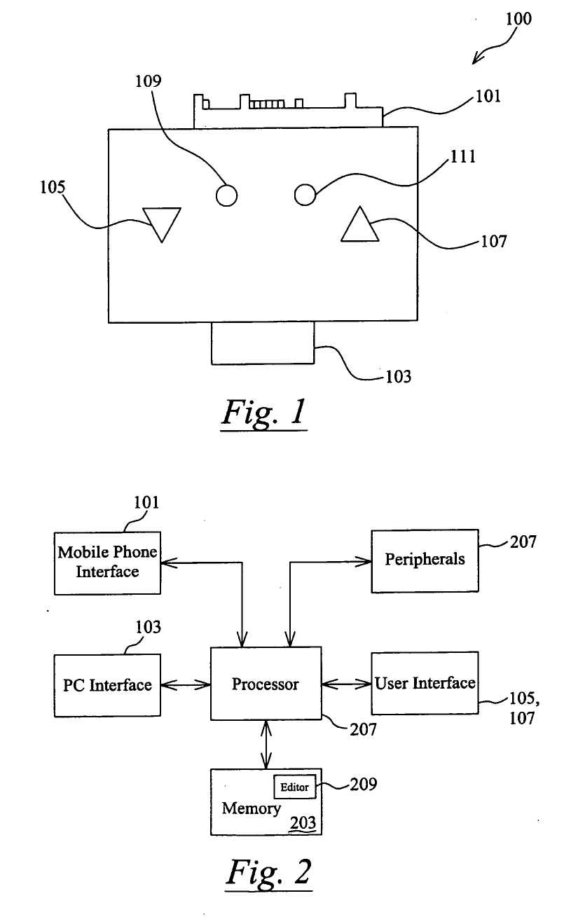

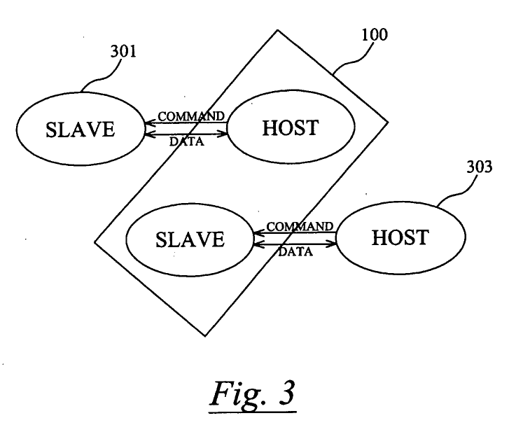

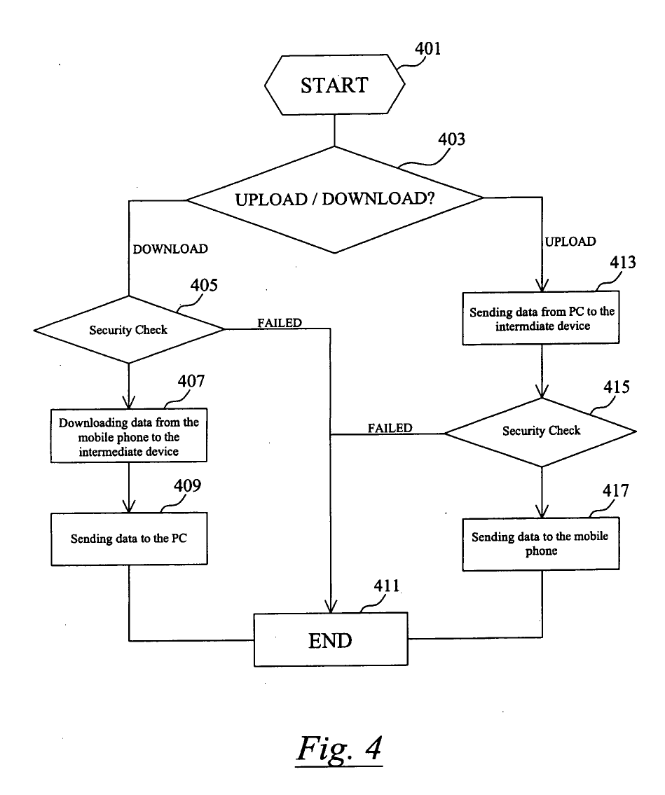

FIG. 1 illustrates an exemplary intermediate device 100 embodiment useful in bidirectional data transfer between a mobile phone 301 (see FIG. 3) and a computing device 303 (see FIG. 3) such as a personal computer. A mobile phone interface 101 is provided at one end of the intermediate device 100 for connecting to the mobile phone. The current application uses a Motorola V60 mobile phone, available from Motorola Inc. in Schaumburg, Ill, for the purpose of illustration. Correspondingly, the intermediate device 100 10 uses a universal asynchronous receive/transmit (hereinafter UART) interface for connecting to such a mobile phone. At the other end of the intermediate device 100, a personal computer interface 103 is provided for connecting to the computer. In specific, a universal serial bus (hereinafter USB) interface is used as the personal computer interface 103 in the illustrative embodiment. Furthermore, the intermediate device 100 communicates with the mobile phone and the computer under the UART protocol and the USB protocol respectively.

In addition, on its body, the intermediate device 100 has a pair of user interfaces 105, 107, both of which appear as a triangle button for its user (not shown) to trigger downloading or uploading of data from or to the mobile phone respectively. The intermediate device 100 also provided a pair of LEDs 109, 111 on its body for the purpose of signaling.

As shown in FIG. 2, the intermediate device 100 has a processor 201 embedded therein for controlling various components of the intermediate device 100, for example, the UART interface 101, the USB interface 103, the user interface 105, 107, and peripherals 207 such the LEDs 109, 111.

Besides, a memory unit 203 is provided in the intermediate device 100 and connects to the processor 201 for storing programs executed by the processor 201, data downloaded from or uploaded to the mobile phone 201, and so on. In addition, an editor 209 is provided in the memory unit 203 for assisting the computer 303 to view and/or edit the downloaded data, which will be discussed in details below.

FIG. 3 simplifies the communication between the intermediate device 100 and the mobile phone 301 as well as the communication between the intermediate device 100 and the computer 303. It is understood that the intermediate device 100 communicates with the mobile phone 301 and the computer 303 under UART and USB protocols respectively, both of which are master-slave protocols. Communicating with the mobile phone 301, the intermediate device 100 acts as a master under the UART protocol. Therefore, the intermediate device 100 controls data exchange between the intermediate device 100 and the mobile phone 301 by sending commands to the mobile phone 301. However, in communication with the computer 303, the intermediate device 100 acts as a slave, while the computer 303 acts as a master under the USB protocol. Thus, data exchange therebetween is now controlled by the computer 303 instead.

FIG. 4 shows step-by-step the flow chart of an exemplary process of bi-directional data transfer between the mobile phone 301 and the computer 303 with assistance of the intermediate device 100. The process starts with step 401, 'start.”

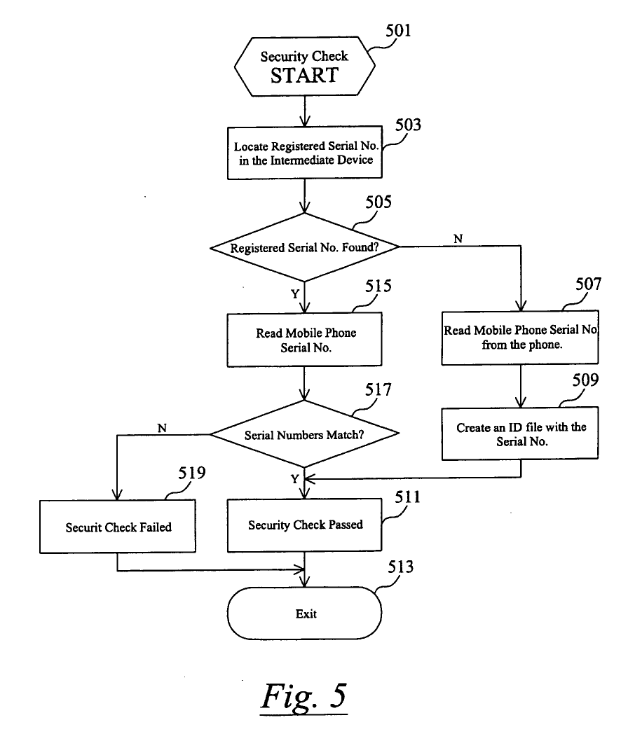

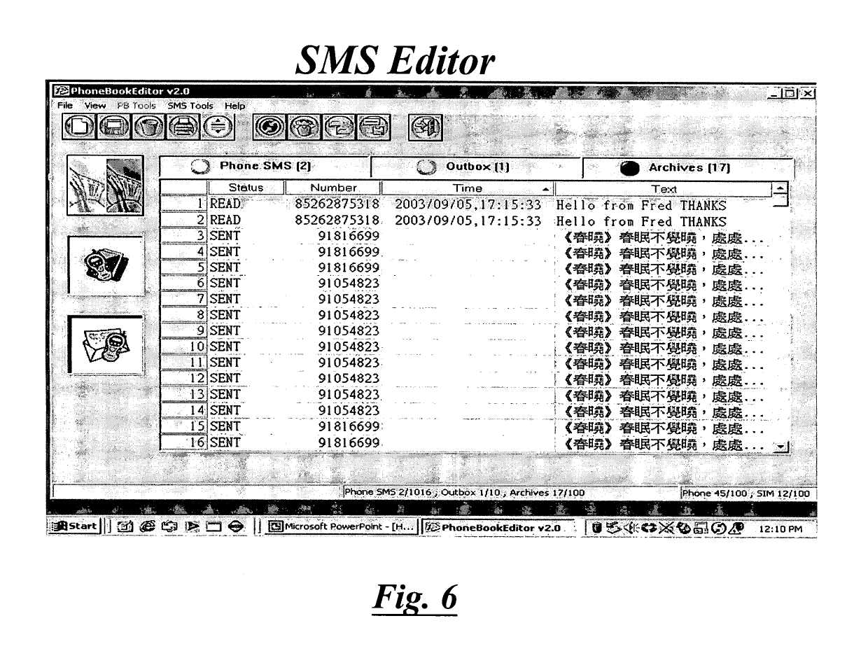

In step 403, the user of the intermediate device 100 selects whether data is to be downloaded from the mobile phone 301 or is to be uploaded to the mobile phone 301. If downloading of data is selected, the intermediate device 100 is firstly connected to the mobile phone 301 through the UART interface 101. After that, in the exemplary embodiment, the user presses the DOWNLOAD button 105 on the body of the intermediate device 100 to trigger a security check step 405 for verifying the mobile phone 301. Such security check step 405 will be described in details with reference to FIG. 5. If the security check fails, that is, the mobile phone 301 is not a registered mobile phone in the intermediate device 100, the process ends, and the intermediate device 100 may signal the user of such an error through twinkling of the LEDs 109, 111. If the mobile phone 301 is verified to be a registered mobile phone in the intermediate device 100, the process enters into step 407.

In step 407, downloading of data from the mobile phone 301 to the intermediate device 100 is performed. The processor 201 firstly sends a command to the mobile phone 301 through the UART interface 101 under the UART protocol, instructing transfer of information such as telephone book and short messages (SMS) from the mobile phone 301 to the intermediate device 100. In response, the mobile phone 301 sends the information as requested to the intermediate device 100. When transfer of the information is completed, the user may detach the intermediate device 100 from the mobile phone 301. It is noted that the intermediate device 100 acts as a master under the UART protocol and therefore controls the communication during the transfer of the information from the mobile phone 301 to the intermediate device 100. It is also noted that the intermediate devices 100 receives the information from the mobile phone 301 as an encoded text file specific to the mobile phone 301 under the UART protocol. The intermediate device 100 then saves such information in its memory unit 203 in the encoded text file format. It is further noted that in the exemplary embodiment, the user selects to download both the telephone book and the SMS. Alternatively, the user may select to just download one of them by appropriately configuring the DOWNLOAD button.

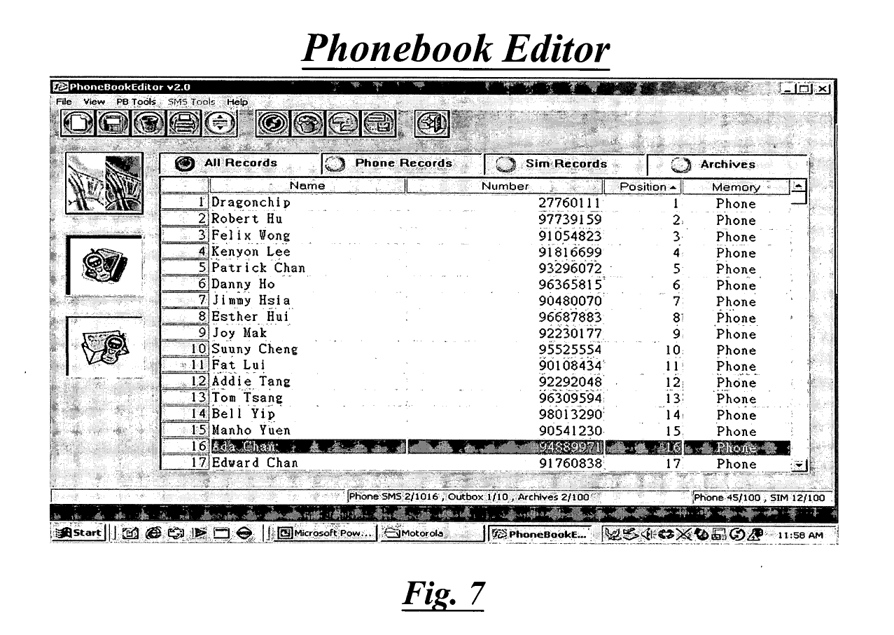

When the user needs to transmit the downloaded information to the computer 303, the user plugs the USB interface 103 of the intermediate device 100 into its corresponding receptacle on the computer 303, and the process enters into step 409. It is noted that the intermediate device 100 communicates with the computer 303 under the USB protocol as generally understood in the art and now acts as a slave under such protocol. Therefore, the user uses the computer 303 to control data transfer from the intermediate device 100 to the computer 303. It is generally understood that most current operating systems allow automatic detection of new devices connected to the computer through USB interfaces. Furthermore, in the exemplary embodiment, the computer 303 detects the intermediate device 100 as a standard storage device under the USB protocol, similar to other devices such as digital cameras. Therefore, the exemplary embodiment of the present invention generally does not require any software installation on the computer 303 under most currently popular operating systems, such as Windows 2000 and so on. Under the illustrative Windows operating system, the user can access the intermediate device 100 by double clicking the “My Computer” icon displayed on the screen (not shown) of the computer 303 and then the “Removable Disk” icon. So when the user needs to view and/or edit the downloaded information from the computer 303, the user may double click an editor icon under the “Removable Disk” to open the editor 209. The editor 209 accordingly decodes the downloaded information, which is saved in the memory unit 203 in the encoded text file format, to a format displayable on the computer 303. The user then can read the downloaded information from the computer 303 directly. FIGS. 6 and 7 illustrate snap-shots of such editor shown on the computer 303.

When data transfer from the intermediate device 100 to the computer 303 is completed, the process ends in step 411.

In step 403, if the user selects to upload data to the mobile phone 301, the intermediate device 100 is firstly connected to the computer 303 though the USB interface 103. As shown in FIGS. 6 and 7, the user may use the editor 209 shown on the computer 303 to edit the information such as SMS and telephone book downloaded from the mobile phone 301. After editing, the user may select to save or not to save the edited information. In the exemplary embodiment, if the user selects to save the edited information, in step 413, the editor 209 automatically encodes the edited information such as telephone book and SMS into the encoded text file format. The computer 303 then transfers such encoded text file incorporating the edited information to the intermediate device 100 through the USB interface 103 under the USB protocol, where the intermediate device 100 acts as a slave under the USB protocol. The processor 201 of the intermediate device 100 controls to receive the encoded text file and then saves it in the memory unit 203. After data transfer from the computer 303 to the intermediate device 100 is completed, in the exemplary embodiment, the user disconnects the intermediate device 100 with the computer 303 first and connects the intermediate device 100 to the mobile phone 301 through the UART interface 101. Then in the exemplary embodiment, the user presses the UPLOAD button 107 on the body of the intermediate device 100 to trigger a security check step 415 similar to step 405. If the security check fails in step 415, the process ends, and the intermediate device 100 may signal the user of such an error through twinkling of the LEDs 109, 111. If the mobile phone 301 is verified to be a registered mobile phone in the intermediate device 100, the process enters into step 417 in which uploading of data to the mobile phone 301 is done.

In step 417, the processor 201 of the intermediate device 100 retrieves from the memory unit 203 the encoded text file, which is specific to the mobile phone 301 and is readable by the mobile phone 301. Thereafter, the processor 201 controls to upload the data to the mobile phone 301 through the UART interface 101 under the UART protocol, where the intermediate device 100 now acts as a master under the UART protocol. Similarly, the user may select to just upload part or all of the data if the UPLOAD button is appropriately configured. When uploading of the data is completed, the process ends in step 411.

FIG. 5 illustrates in details the security check performed in steps 405 and 415. The security check starts in step 501. In step 503, the processor 201 searches in the memory unit 203 for a pre-registered mobile phone serial number in the form of, for example, international mobile subscriber identity (IMEI), mobile identity number (MIN), or international mobile subscriber identity (IMSI). In step 505, the processor 201 determines whether there is such a pre-registered mobile phone serial number in the memory unit 203. If such a pre-registered mobile phone serial number is found, the security check process enters into step 515, in which the processor 201 reads the mobile phone's serial number through the UART interface 101. Then in step 517, the processor 201 determines whether the downloaded mobile phone serial number matches the pre-registered mobile phone serial number. If these two serial numbers match each other, the security check is passed in step 511, and the security check process ends in step 513. If these two serial numbers do not match each other, the security check process fails, and in step 519 the processor 201 may send an error message to the mobile phone 301 for display. The security process then ends in step 513.

In step 505, if there is no pre-registered mobile phone serial number stored in the memory unit 203, the security check process enters into step 507. In step 507, the processor 201 downloads through the UART interface 101 the mobile phone serial number of the mobile phone 301, which is currently connected to the intermediate device 100. Then in step 509, the processor 201 stores the downloaded mobile phone serial number in the memory unit 203. Thereafter, the downloaded mobile phone serial number becomes the pre-registered mobile phone serial number and will be used for security check purpose. The security check process then goes to step 511, and the security check is passed.

Alternatives can be made to the exemplary embodiment described thereabove. For example, the intermediate device 100 can be used for data transfer between the mobile phone and other computing devices such as a personal digital assistant (PDA); the mobile phone may incorporate other functions such as PDAs or digital cameras. Furthermore, in the exemplary embodiment, the editor 209 decodes the downloaded information and also encodes the information, which has been edited by the user and is to be uploaded. Alternatively, the processor 201 can provide a data conversion function, which automatically converts the downloaded information to a file in a format readable and/or editable by the computer 303. The processor then saves such a file in its memory unit 203, and the computer 303 can directly retrieve such a file from the intermediate device when they are connected. During uploading, the intermediate device 100 receives the information to be uploaded from the computer 303 in the same format, that is, a format readable by the computer. The processor 203 then uses its data conversion function to convert such information to a format suitable for the mobile phone 301 before uploading to the mobile phone 301. In addition, instead of the UART and USB protocols, the present invention may use other various protocols, preferably also master-lave protocols. In that case, corresponding interfaces are to be used. Besides, it is understood that the intermediate device can be used for transfer of other types of data such as photos, ring tones and games between the mobile phone and the computer.

What is claimed is:

1. A process for bi-directionally transferring data between a mobile phone and a computing device, comprising
selecting between an uploading mode and a downloading mode;
if the downloading mode is selected,
firstly downloading a first data from the mobile phone to an intermediate device under a first master-slave protocol, wherein the intermediate device herein acts as a master device under the first master-slave protocol; and
secondly transmitting the first data from the intermediate device to the computing device under a second master-slave protocol, wherein the intermediate device herein acts as a slave device under the second master-slave protocol; and
if the uploading mode is selected,
firstly transmitting a second data from the computing device to the intermediate device under the second master-slave protocol, wherein the intermediate device herein acts as a slave device under the second master-slave protocol; and
secondly uploading the second data from the intermediate device to the mobile under the first master-slave protocol, wherein the intermediate device herein acts as a master device under the first master-slave protocol.

2. The process of claim 1, further comprising
prior to downloading the first data from the mobile phone to the intermediate device, performing a security check step for verifying the mobile phone.

3. The process of claim 2, further comprising
prior to uploading the second data from the intermediate device to the mobile phone, performing the security check step for verifying the mobile phone.

4. The process of claim 2, wherein the security check step includes
pre-registering in the intermediate device an identification token of the mobile phone.

5. The process of claim 2, wherein the security check step includes
downloading a mobile phone serial number from the mobile device to the intermediate device; and
comparing the downloaded mobile phone serial number with a pre-registered mobile phone serial number stored in the intermediate device for security check.

6. The process of claim 1, further comprising
prior to uploading the second data from the intermediate device to the mobile phone, converting the second data to a format suitable for receipt by the mobile device.

7. A medium, having a program recorded thereon, wherein the program makes an intermediate device execute a procedure comprising the following steps for bi-directionally transferring data between a mobile phone and a computing device, comprising
selecting between an uploading mode and a downloading mode;
if the downloading mode is selected,
firstly downloading a first data from the mobile phone to the intermediate device under a first master-slave protocol, wherein the intermediate device herein acts as a master device under the first master-slave protocol; and
secondly transmitting the first data from the intermediate device to the computing device under a second master-slave protocol, wherein the intermediate device herein acts as a slave device under the second master-slave protocol; and
if the uploading mode is selected,
firstly transmitting a second data from the computing device to the intermediate device under the second master-slave protocol, wherein the intermediate device herein acts as a slave device under the second master-slave protocol; and
secondly uploading the second data from the intermediate device to the mobile under the first master-slave protocol, wherein the intermediate device herein acts as a master device under the first master-slave protocol.

8. A computer program element which makes an intermediate device execute a procedure comprising the following steps for bi-directionally transferring data between a mobile phone and a computing device, comprising
selecting between an uploading mode and a downloading mode;
if the downloading mode is selected,
firstly downloading a first data from the mobile phone to the intermediate device under a first master-slave protocol, wherein the intermediate device herein acts as a master device under the first master-slave protocol; and
secondly transmitting the first data from the intermediate device to the computing device under a second master-slave protocol, wherein the intermediate device herein acts as a slave device under the second master-slave protocol; and
if the uploading mode is selected,
firstly transmitting a second data from the computing device to the intermediate device under the second master-slave protocol, wherein the intermediate device herein acts as a slave device under the second master-slave protocol; and
secondly uploading the second data from the intermediate device to the mobile under the first master-slave protocol, wherein the intermediate device herein acts as a master device under the first master-slave protocol.

9. A process for bi-directionally transferring data between a mobile phone and a computing device, comprising
selecting between an uploading mode and a downloading mode;
if the downloading mode is selected,
firstly downloading a first data from the mobile phone to an intermediate device under a first protocol; and
secondly transmitting the first data from the intermediate device to the computing device under a second protocol; and
if the uploading mode is selected,
firstly transmitting a second data from the computing device to the intermediate device under the second protocol; and
secondly uploading the second data from the intermediate device to the mobile under the first protocol.

10. The process of claim 9, wherein the first and second protocols are different master-slave protocols.

11. An intermediate device for assisting bidirectional data transfer between a mobile phone and a computing device, comprising
a mobile phone interface for connecting to the mobile phone;
a computing device interface for connecting to the computing device;
a controller for controlling data flow through the mobile phone interface and the computing device interface; and
a user interface for allowing a user to select the intermediate device to work in an uploading mode or a downloading mode,
wherein if the uploading mode is selected, the controller controls to receive a second data from the computing device to the intermediate device through the computing device interface under a second protocol, and wherein the controller further controls to upload the second data from the intermediate device to the mobile through the mobile phone interface under a first protocol.

12. The intermediate device of claim 11, wherein if the downloading mode is selected, the controller controls to download a first data from the mobile device to the intermediate device through the mobile device interface under the first protocol, and wherein the controller further controls to send the first data from the intermediate device to the computing device through the computing interface under the second protocol.

13. The intermediate device of claim 12, wherein the first and the second protocols are master-slave protocols, and wherein the intermediate device acts as a master device under the first protocol, but acts as a slave device under the second protocol.

14. The intermediate device of claim 11, further comprising a converter controlled by the controller for converting the second data retrieved from the computing device to a format suitable for receipt by the mobile device prior to uploading to the mobile device.
